(19) United States
(12) Patent Application Publication
(10) Pub. No.: US 2022/0036200 A1
(43) Pub. Date: Feb. 3, 2022

(54) RULES AND MACHINE LEARNING TO PROVIDE REGULATORY COMPLIED FRAUD DETECTION SYSTEMS

(71) Applicant: International Business Machines Corporation, Armonk, NY (US)

(72) Inventors: Yi-Hui Ma, Mechanicsburg, PA (US); Willie Robert Patten, JR., Hurdle Mills, NC (US)

(21) Appl. No.: 16/940,944

(22) Filed: Jul. 28, 2020

(51) Int. Cl. G06N 5/00; G06N 20/00; G06N 5/04; G06Q 20/40

(52) U.S. Cl. CPC G06N 5/003; G06Q 20/4016; G06N 5/04; G06N 20/00

(57) ABSTRACT

An approach is provided that receives data sets pertaining to entities. The received data sets are analyzed using a trained artificial intelligence (AI) system, with the analysis results in a fraud probability level. In response to the probability level indicating a high probability of fraud, a rule-based decision tree is applied to the received set of data. A behavior pattern is identified based on a result of the rule-based decision tree and this behavior pattern is used to identify a possible fraudulent event pertaining one of the entities.

### BACKGROUND

Analyzing an environment for regulatory compliance is difficult, even when applying artificial intelligence (AI) and machine learning (ML) technologies. One reason for this difficulty is due to regulatory compliance having particular, explicit rules that have to be applied to determine whether compliance is achieved. While AI and ML techniques are good tools for making predictions, they often fall short with environments that involve definitive statements. With regard to regulatory compliance, traditional AI/ML approaches do not provide a definitive statement, and thus use of these types of models do not provide definitive assurances that an organization is in compliance with particular regulations.

### SUMMARY

An approach is provided that receives data sets pertaining to entities. The received data sets are analyzed using a trained artificial intelligence (AI) system, with the analysis results in a fraud probability level. In response to the probability level indicating a high probability of fraud, a rule-based decision tree is applied to the received set of data. A behavior pattern is identified based on a result of the rule-based decision tree and this behavior pattern is used to identify a possible fraudulent event pertaining one of the entities.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a network environment that includes a knowledge manager that utilizes a knowledge base;

FIG. 2 is a block diagram of a processor and components of an information handling system such as those shown in FIG. 1;

FIG. 3 is a diagram that shows stages of artificial intelligence and decision tree processing to discover patterns in data;

FIG. 4 is a depiction of a flowchart showing the logic used to use artificial intelligence and a rule-based decision tree to discover patterns in data; and

FIG. 5 is a depiction of a flowchart showing the logic used to analyze results found by artificial intelligence and rule-based decision tree processing to discover patterns in processed datasets.

### DETAILED DESCRIPTION

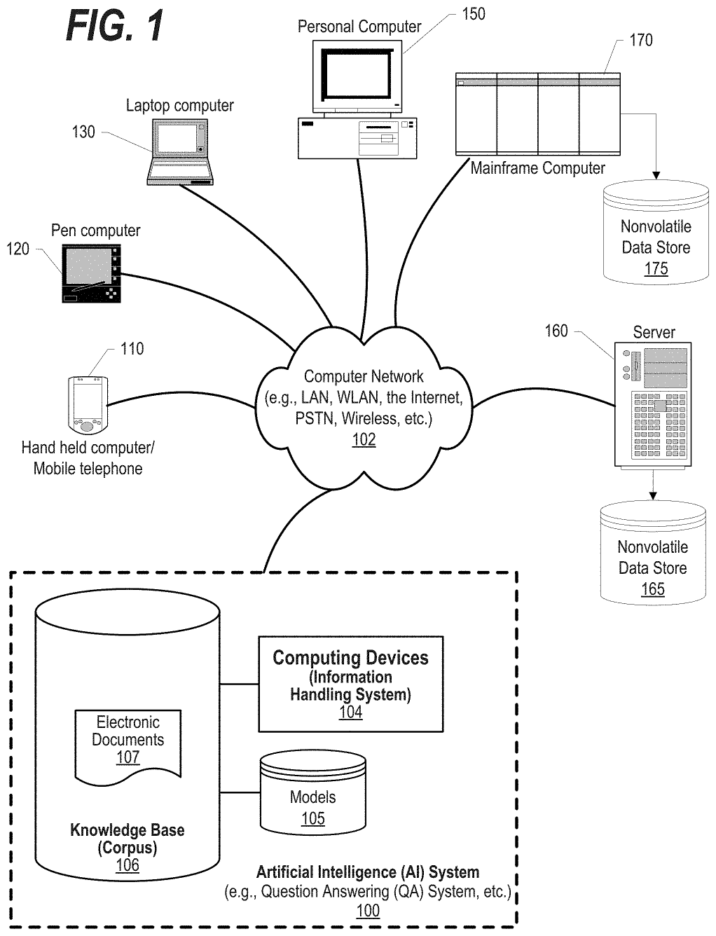

FIGS. 1-5 describe an approach that determines the riskiness of an entity, such as a customer, in terms of compliance to better prioritize a review process. The problem space can be viewed as concentric circles. Inner circles represent customers whose behaviors are easier to identify, while outer circles represent customers whose behaviors are more difficult to identify. Customers identified by inner circles usually have higher separability, meaning that they have distinct features that make them easier to identify. This usually corresponds to simpler and easier to explain solutions such as linear regression or application of a simple decision tree. By separating the problem space into inner and outer circles, rules can be applied in the higher separability space to help extract better insights to ensure the compliance of applicable rules.

The approach uses high performance results from artificial intelligence (AI) system (machine learning or “ML”) and separates the problem space into a manageable number of concentric circles, such as three circles. In addition, the approach generates rules for inner circles to provide better supporting evidence.

The approach takes an ensemble approach to combine different model results for final scoring and evidence creation. Using an ensemble approach combines the results from AI/ML model predictions with the explicit determination of meeting requirements found in deterministic approaches such as decision trees. During model training and building phase, the approach starts with machine learning algorithms from a trained system to find initial confidence scores. Data resulting in higher confidence scores as well as those that match behavior patterns are identified as inner circle candidates. These inner circle problems can then be fed into a deterministic decision tree to generate rules that are combined with domain-specific rules to provide understandable supporting evidence. During the scoring phase, each entity, such as customers, is processed by both the AI/ML process as well as the rule-based (decision tree) model. A different ensemble score can be generated using either a sequential process approach or a weighted approach.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIG. 1 depicts a schematic diagram of one illustrative embodiment of artificial intelligence (AI) system 100, such as a question/answer creation (QA) system, in a computer network 102. AI system 100 may include a knowledge manager computing device 104 (comprising one or more processors and one or more memories, and potentially any other computing device elements generally known in the art including buses, storage devices, communication interfaces, and the like) that connects AI system 100 to the computer network 102. The network 102 may include multiple computing devices 104 in communication with each other and with other devices or components via one or more wired and/or wireless data communication links, where each communication link may comprise one or more of wires, routers, switches, transmitters, receivers, or the like. AI system 100 and network 102 may enable question/answer (QA) generation functionality for one or more content users. Other embodiments of AI system 100 may be used with components, systems, sub-systems, and/or devices other than those that are depicted herein.

AI system 100 uses AI model 105 that is a result of training the AI system. The model is a mathematical model that generates predictions by finding patterns in the data stored in corpus 106. In artificial intelligence, AI models 105 are based on the reasoning that works on methods in the AI system. AI models 105 observe data in corpus 106 to derive conclusions and make predictions about such data.

AI system 100 may be configured to receive inputs from various sources. For example, AI system 100 may receive input from the network 102, a corpus of electronic documents 107 or other data, a content creator, content users, and other possible sources of input. In one embodiment, some or all of the inputs to AI system 100 may be routed through the network 102. The various computing devices on the network 102 may include access points for content creators and content users. Some of the computing devices may include devices for a database storing the corpus of data. The network 102 may include local network connections and remote connections in various embodiments, such that knowledge manager 100 may operate in environments of any size, including local and global, e.g., the Internet. Additionally, knowledge manager 100 serves as a front-end system that can make available a variety of knowledge extracted from or represented in documents, network-accessible sources and/or structured data sources. In this manner, some processes populate the knowledge manager with the knowledge manager also including input interfaces to receive knowledge requests and respond accordingly.

In one embodiment, the content creator creates content in electronic documents 107 for use as part of a corpus of data with AI system 100. Electronic documents 107 may include any file, text, article, or source of data for use in AI system 100. Content users may access AI system 100 via a network connection or an Internet connection to the network 102, and may input questions to AI system 100 that may be answered by the content in the corpus of data. As further described below, when a process evaluates a given section of a document for semantic content, the process can use a variety of conventions to query it from the knowledge manager. One convention is to send a well-formed question. Semantic content is content based on the relation between signifiers, such as words, phrases, signs, and symbols, and what they stand for, their denotation, or connotation. In other words, semantic content is content that interprets an expression, such as by using Natural Language (NL) Processing. Semantic data 108 is stored as part of the knowledge base 106. In one embodiment, the process sends well-formed questions (e.g., natural language questions, etc.) to the knowledge manager. AI system 100 may interpret the question and provide a response to the content user containing one or more answers to the question. In some embodiments, AI system 100 may provide a response to users in a ranked list of answers.

In some illustrative embodiments, AI system 100 may be the IBM Watson™ QA system available from International Business Machines Corporation of Armonk, N.Y., which is augmented with the mechanisms of the illustrative embodiments described hereafter. The IBM Watson™ knowledge manager system may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The IBM Watson™ QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e. candidate answer, is inferred by the question. This process may be repeated for each of the candidate answers until the IBM Watson™ QA system identifies candidate answers that surface as being significantly stronger than others and thus, generates a final answer, or ranked set of answers, for the input question.

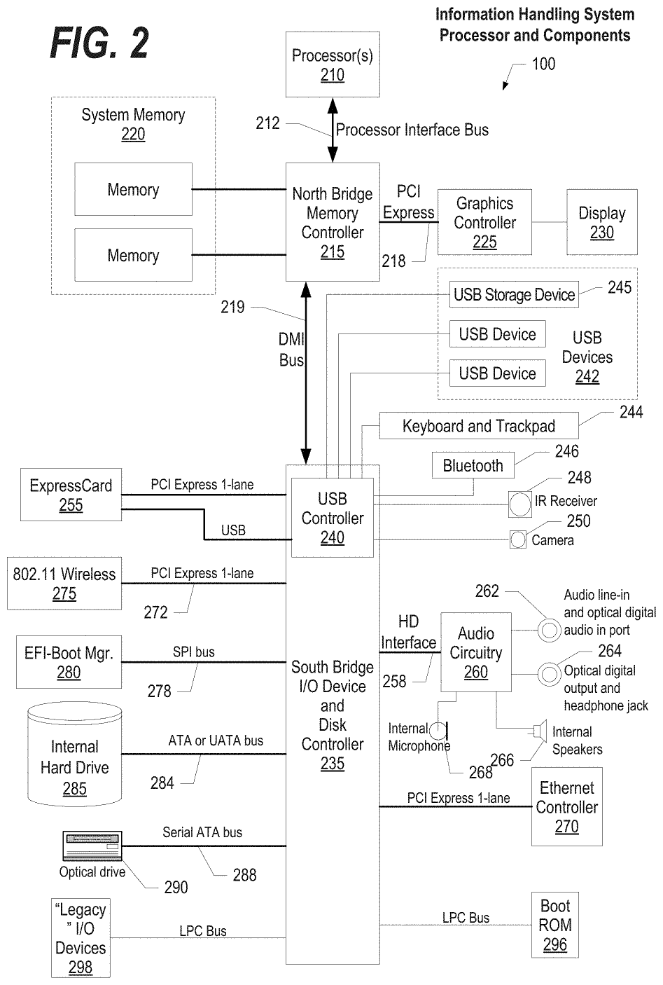

Types of information handling systems that can utilize AI system 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. As shown, the various information handling systems can be networked together using computer network 102. Types of computer network 102 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 1 depicts separate nonvolatile data stores (server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, more particularly, a processor and common components, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219. In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. The LPC bus also connects Southbridge 235 to Trusted Platform Module (TPM) 295. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, modems, network cards, ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, etcetera.

Wireless Local Area Network (LAN) device 275 connects to Southbridge 235 via the PCI or PCI Express bus 272. LAN device 275 typically implements one of the IEEE 802.11 standards of over-the-air modulation techniques that all use the same protocol to wireless communicate between information handling system 200 and another computer system or device. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

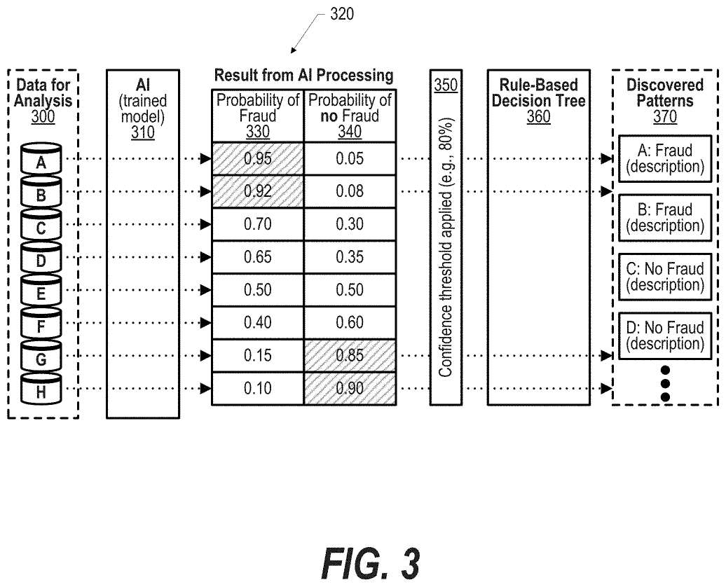

FIG. 3 is a diagram that shows stages of artificial intelligence and decision tree processing to discover patterns in data. Element 300 depicts any number of sets of data that pertain to any number of entities, such as customers. The sets of data may include transactions conducted by the various entities from which the system can derive sets of behavior to attribute to the various entities.

Sets of data 300 that pertain to entities are analyzed by trained artificial intelligence (AI) system 310. The results of the analysis by the trained AI system are fraud probability levels 320. In the example shown, the probability that an entity exhibits fraud based on the processed transactions is depicted as the probability of fraud column 330 with the probability of non-fraud being shown for the same entity in column 340. In the example, the results have been sorted from greater predictions of fraud at the top to less predictions of fraud at the bottom.

Confidence threshold 350 is applied to the fraud prediction data to determine which of the entities' transactions are to be further processed by a deterministic process, such as a rule-based decision tree. In the example shown, an eighty percent threshold is applied so that the top two entities, predicted as having fraud probabilities greater than eighty percent, are passed through the threshold. In one embodiment, entities with non-fraud probabilities greater than the applied threshold are also passed to the deterministic process, such as the rule-based decision tree. Using this embodiment, in the example shown, the bottom two entities are also passed through to the deterministic process.

A deterministic process, such as rule-based decision tree process 360 is then used to process the data corresponding to the entities that met threshold 350, in this case the two upper and lower entities. Processing by the rule-based decision tree results in patterns that are discovered for the entities in question, such as why a particular entity behavior is found to be a behavior indicating fraud or, conversely, why the particular entity behavior is found to indicate non-fraudulent behavior. In one embodiment, the discovered patterns are fed back to AI model 310 to further train the model regarding various types of patterns (fraudulent and non-fraudulent) that helps the AI model better predict such behavior based on entity data (e.g., transaction data, etc.) for future processing performed by the AI system against other entity data. The resulting discovered patters are depicted as stored in element 370 and can be used to look into fraudulent behavior as well as to further train the model utilized AI system to process entity data sets to predict which data sets indicate fraudulent or non-fraudulent behavior on behalf of the respective entities.

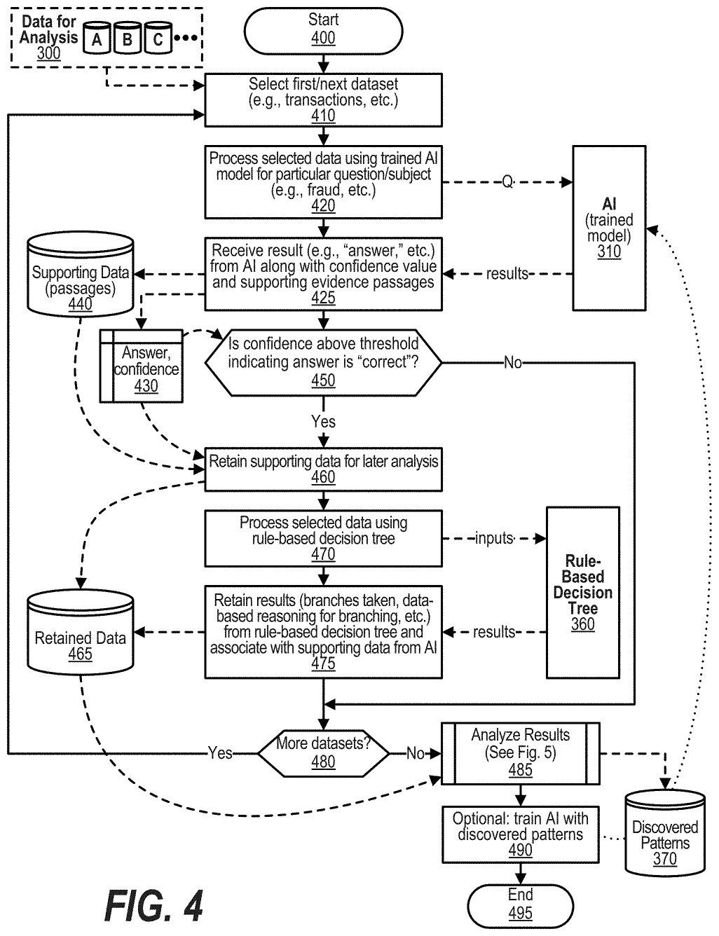

FIG. 4 is a depiction of a flowchart showing the logic used to use artificial intelligence and a rule-based decision tree to discover patterns in data. FIG. 4 processing commences at 400 and shows the steps taken by a process that provides rules and machine learning to provide a regulatory compliance fraud detection system. At step 410, the process selects the first dataset (e.g., transactions, etc.) from one or more sets of data 300 that pertain to entities, such as customers, being processed by the routine. At step 420, the selected data is processed by the routine using trained artificial intelligence (AI) model 310 for a particular question/subject, such as a question or subject related to fraud in a particular field or domain. At step 425, the process receives a result from AI system 310. In a system utilizing a question/answer (QA) system as part of the AI, the result might be an ‘answer’ to a question posed to the AI system. The result is provided to the routine along with a confidence value and supporting evidence passages from the data set that support the answer, or result, provided by the AI system. The supporting data, such as passages found in the selected set of data, are retained in data store 440.

The process determines whether the confidence value provided by the AI system is above a predefined threshold that indicates that the answer is a “correct” answer (decision 450). If the confidence value is above the threshold indicating that the answer is “correct”, then decision 450 branches to the ‘yes’ branch to perform steps 460 through 475. On the other hand, if the confidence value is not above the threshold that indicates that the answer is “correct”, then decision 450 branches to the ‘no’ branch bypassing steps 460 through 475.

Steps 460 through 475 are performed when the confidence value is above the threshold indicating a high likelihood that the AI's result was correct. At step 460, the process retains the supporting data returned by the AI system for later analysis. The data is retained in data store 465. At step 470, rule-based decision tree 360 processes the selected data using rules established for the rule-based decision tree. Such rules may be determined based on the industry or type of environment that is being analyzed for fraudulent behavior. At step 475, the process receives and retains results from the rule-based decision tree. These results include the branches that were taken by the rule-based decision tree as well as the data-based reasoning for performing such branching. The results from the rule-based decision tree are then associated with the results and other supporting data from the AI system's processing of the same data. The data and the associations are stored in data store 465.

The process determines as to whether there are more sets of data to process (decision 480). If there are more sets of data to process, then decision 480 branches to the ‘yes’ branch which loops back to step 410 to select and process the next set of data as described above. This looping continues until there are no more sets of data to process, at which point decision 480 branches to the ‘no’ branch exiting the loop.

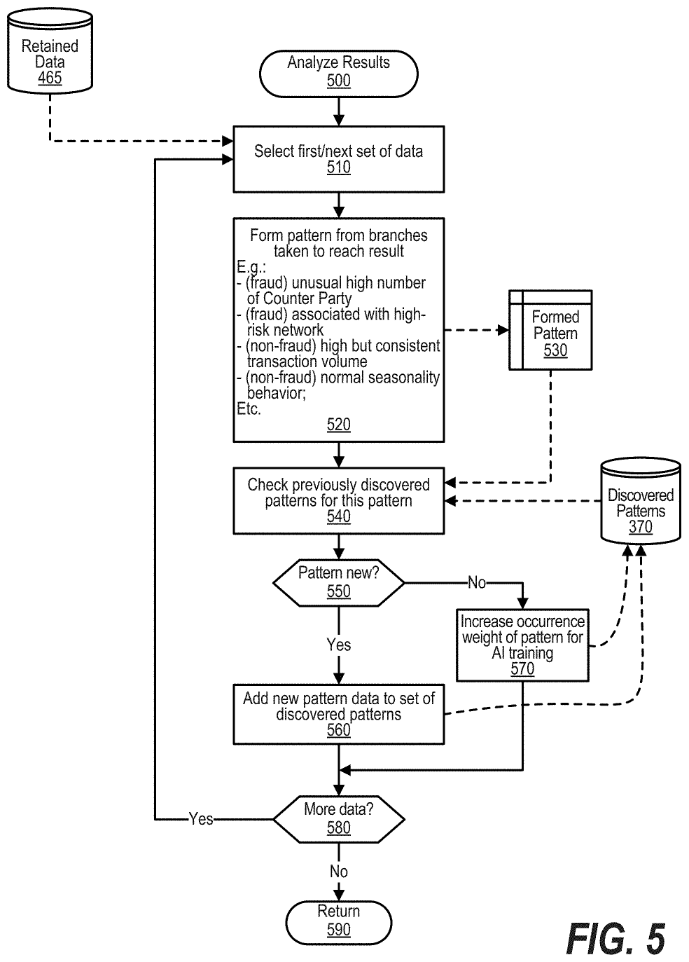

At predefined process 485, the process performs the Analyze Results routine (see FIG. 5 and corresponding text for processing details). This routine results in sets of discovered patterns that reveal the fraudulent behavior discovered by the processing of the data using the AI and decision-based decision tree systems. The resulting set of discovered patterns are stored in data store 370. At step 490, the process may perform an optional step to further train the AI system using the discovered patterns that were stored in data store 370. FIG. 4 processing thereafter ends at 495.

FIG. 5 is a depiction of a flowchart showing the logic used to analyze results found by artificial intelligence and rule-based decision tree processing to discover patterns in processed datasets. FIG. 5 processing commences at 500 and shows the steps taken by a process that analyzes the results from the AI and rule-based decision tree processes. At step 510, the process selects the first set of data from retained data 465.

At step 520, the process forms a pattern from the branches that were taken by the rule-based decision tree process to reach the result. For examples, a pattern might indicate (fraud) where an unusual high number of Counter Party occurred, and (fraud) when associated with a high-risk network. A non-fraud pattern might be found where there are high but consistent transaction volume, and also when normal seasonality behavior is found. The pattern formed from the branches taken is stored in memory area 530. At step 540, the process checks the previously discovered patterns for this pattern to see if it is a newly discovered pattern.

The process determines whether this pattern is a new pattern that has not previously been discovered (decision 550). If the pattern is new, then decision 550 branches to the ‘yes’ branch whereupon at step 560, the process adds the new pattern data to the set of discovered patterns that are stored in data store 370. On the other hand, if the pattern is not new and has already been discovered, then decision 550 branches to the ‘no’ branch whereupon, at step 570, the process increases the occurrence weight of this pattern for future AI training with the weight data being included in data store 370. The process determines whether there is more data to process from retained data 465 (decision 580). If there is more retained data to process, then decision 580 branches to the ‘yes’ branch which loops back to step 510 to select and process the next set of data as described above. This looping continues until all of the data has been processed, at which point decision 580 branches to the ‘no’ branch exiting the loop and processing returns to the calling routine (see FIG. 4) at 590.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method implemented by an information handling system that includes a processor and a memory accessible by the processor, the method comprising:
receiving one or more sets of data pertaining to a plurality of entities;
analyzing the received sets of data using a trained artificial intelligence (AI) system, wherein the analysis results in a fraud probability level;
applying a rule-based decision tree to the received set of data based on the resulting fraud probability level;
identifying a pattern based on a result of the rule-based decision tree; and
detecting a possible fraudulent event pertaining to a behavior pattern corresponding to a selected one of the plurality of entities.

2. The method of claim 1 wherein the fraud probability level corresponds to a confidence score in response to the AI system's analysis of a plurality of behavior patterns included in the sets of data.

3. The method of claim 2 further comprising:
applying the rule-based decision tree in response to the confidence score reaching a predetermined threshold.

4. The method of claim 1 further comprising
forming the behavior pattern from a plurality of logic branches included in the sets of data that reach a result.

5. The method of claim 4 further comprising
training the AI system using the formed behavior pattern.

6. The method of claim 1 further comprising
retaining AI resulting data that includes an answer corresponding to each of the plurality of entities, a confidence value corresponding to each of the answers, and one or more sets of supporting passages found in the sets of data by the AI system; and
retaining decision-tree resulting data that includes a plurality of branches taken by the rule-based decision tree along with a data-based reasoning corresponding to one or more of the plurality of branches; and
associating the retained decision-tree resulting data with the AI resulting data that corresponds to the same entity.

7. The method of claim 6 further comprising:
forming one or more behavior patterns from the plurality of branches included in the decision-tree resulting data, wherein at least one of the behavior branches is selected from the group consisting of (1) an unusual number of counter party occurrences indicting fraud, (2) an association with a high risk network indicating fraud, (3) a high but consistent transaction volume indicating non-fraud, and (4) a normal seasonal behavior indicating non-fraud.

8. An information handling system comprising:
one or more processors;
a memory coupled to at least one of the processors; and
a set of computer program instructions stored in the memory and executed by at least one of the processors in order to perform actions comprising:
receiving one or more sets of data pertaining to a plurality of entities;
analyzing the received sets of data using a trained artificial intelligence (AI) system, wherein the analysis results in a fraud probability level;
applying a rule-based decision tree to the received set of data based on the resulting fraud probability level;
identifying a pattern based on a result of the rule-based decision tree; and
detecting a possible fraudulent event pertaining to a behavior pattern corresponding to a selected one of the plurality of entities.

9. The information handling system of claim 8 wherein the fraud probability level corresponds to a confidence score in response to the AI system's analysis of a plurality of behavior patterns included in the sets of data.

10. The information handling system of claim 9 wherein the actions further comprise:
applying the rule-based decision tree in response to the confidence score reaching a predetermined threshold.

11. The information handling system of claim 8 wherein the actions further comprise
forming the behavior pattern from a plurality of logic branches included in the sets of data that reach a result.

12. The information handling system of claim 11 wherein the actions further comprise
training the AI system using the formed behavior pattern.

13. The information handling system of claim 8 wherein the actions further comprise
retaining AI resulting data that includes an answer corresponding to each of the plurality of entities, a confidence value corresponding to each of the answers, and one or more sets of supporting passages found in the sets of data by the AI system; and
retaining decision-tree resulting data that includes a plurality of branches taken by the rule-based decision tree along with a data-based reasoning corresponding to one or more of the plurality of branches; and
associating the retained decision-tree resulting data with the AI resulting data that corresponds to the same entity.

14. The information handling system of claim 13 wherein the actions further comprise:
forming one or more behavior patterns from the plurality of branches included in the decision-tree resulting data, wherein at least one of the behavior branches is selected from the group consisting of (1) an unusual number of counter party occurrences indicting fraud, (2) an association with a high risk network indicating fraud, (3) a high but consistent transaction volume indicating non-fraud, and (4) a normal seasonal behavior indicating non-fraud.

15. A computer program product stored in a computer readable storage medium, comprising computer program code that, when executed by an information handling system, performs actions comprising:
receiving one or more sets of data pertaining to a plurality of entities;
analyzing the received sets of data using a trained artificial intelligence (AI) system, wherein the analysis results in a fraud probability level;
applying a rule-based decision tree to the received set of data based on the resulting fraud probability level;
identifying a pattern based on a result of the rule-based decision tree; and
detecting a possible fraudulent event pertaining to a behavior pattern corresponding to a selected one of the plurality of entities.

16. The computer program product of claim 15 wherein the fraud probability level corresponds to a confidence score in response to the AI system's analysis of a plurality of behavior patterns included in the sets of data.

17. The computer program product of claim 16 wherein the actions further comprise:
applying the rule-based decision tree in response to the confidence score reaching a predetermined threshold.

18. The computer program product of claim 15 wherein the actions further comprise
forming the behavior pattern from a plurality of logic branches included in the sets of data that reach a result.

19. The computer program product of claim 18 wherein the actions further comprise
training the AI system using the formed behavior pattern.

20. The computer program product of claim 15 wherein the actions further comprise
retaining AI resulting data that includes an answer corresponding to each of the plurality of entities, a confidence value corresponding to each of the answers, and one or more sets of supporting passages found in the sets of data by the AI system; and
retaining decision-tree resulting data that includes a plurality of branches taken by the rule-based decision tree along with a data-based reasoning corresponding to one or more of the plurality of branches; and
associating the retained decision-tree resulting data with the AI resulting data that corresponds to the same entity.
